(19) United States
(12) Patent Application Publication
(10) Pub. No.: US 2018/0091556 A1
(43) Pub. Date: Mar. 29, 2018

(54) SYSTEM AND METHOD FOR PACKET CLASSIFICATION USING MULTIPLE SECURITY DATABASES

(71) Applicant: Futurewei Technologies, Inc., Plano, TX (US)

(72) Inventors: Yan Sun, Santa Clara, CA (US); Yunsong Lu, Mountain View, CA (US); Wenzhe Zhou, Cupertino, CA (US)

(21) Appl. No.: 15/280,881

(22) Filed: Sep. 29, 2016

(51) Int. Cl. H04L 29/06; G06F 17/30

(52) U.S. Cl. CPC H04L 63/20; H04L 63/06; H04L 63/0428; H04L 63/0263; G06F 17/30864; H04L 63/08

(57) ABSTRACT

A packet classification system is provided, including a first security database and a second security database for use in connection with packet classification in accordance with an Internet security protocol. The packet classification system further includes processing circuitry in communication with the first security database and the second security database, with the processing circuitry configured to identify at least one aspect of at least one packet received by the processing circuitry, select either the first security database or the second security database as a selected security database, based on the at least one aspect of the at least one packet, select at least one of a plurality of algorithms to classify the at least one packet, wherein the selection of the at least one algorithm is based on a criteria related to the at least one packet, and classify the at least one packet, utilizing the selected security database.

### FIELD OF THE INVENTION

The present invention relates to communication systems, and more particularly to packet classification in connection with Internet security protocols.

### BACKGROUND

Internet Protocol Security (IPsec) is a protocol suite for providing secure Internet Protocol (IP) communications by authenticating and encrypting IP packets of a communication session. IPsec includes protocols for establishing mutual authentication between agents at the beginning of the session, and negotiation of cryptographic keys to be used during the session. Further, such protocol suite can be used in protecting data flows between a pair of hosts (host-to-host), between a pair of security gateways (network-to-network), or between a security gateway and a host (network-to-host). To accomplish this, IPsec uses cryptographic security services to protect communications over IP networks, and supports network-level peer authentication, data origin authentication, data integrity, data confidentiality (encryption), and replay protection.

In operation, an IPSec driver uses a security association database (SAD) and a security policy database (SPD), for performing packet classification. For security and other reasons, the SAD and SPD are updated periodically. As systems are required to handle more and more traffic, the contents of the SAD and SPD grow exponentially and must be updated more frequently and with greater speed. As such, the use and updating of the SAD and SPD are increasingly viewed as a bottleneck to the packet classification that such databases support.

### SUMMARY

A packet classification system is provided, including a first security database and a second security database for use in connection with packet classification in accordance with an Internet security protocol. The packet classification system further includes processing circuitry in communication with the first security database and the second security database, with the processing circuitry configured to identify at least one aspect of at least one packet received by the processing circuitry, select either the first security database or the second security database as a selected security database, based on the at least one aspect of the at least one packet, select at least one of a plurality of algorithms to classify the at least one packet, wherein the selection of the at least one algorithm is based on a criteria related to the at least one packet, and classify the at least one packet, utilizing the selected security database.

In a first embodiment, the first security database and the second security database may each include a security association database (SAD).

In a second embodiment (which may or may not be combined with the first embodiment), the first security database and the second security database may each include a security policy database (SPD).

In a third embodiment (which may or may not be combined with the first and/or second embodiments), the Internet security protocol may include an Internet Protocol Security (IPsec) protocol and/or a secure socket layer (SSL) protocol.

In a fourth embodiment (which may or may not be combined with the first, second, and/or third embodiments), the first security database and the second security database may be generated by dividing a particular security database such that the first security database includes a first subset of the particular security database and the second security database includes a second subset of the particular security database.

In a fifth embodiment (which may or may not be combined with the first, second, third, and/or fourth embodiments), the at least one aspect of the at least one packet may include a subnet identified by the at least one packet, a flow identified by the at least one packet, and/or a virtual local area network (VLAN) identified by the at least one packet. As a further option, the at least one aspect of the at least one packet may involve whether the at least one packet is an incoming packet or an outgoing packet. In accordance with such option, the first security database may be configured for use in connection with packet classification of incoming packets, and the second security database may be configured for use in connection with packet classification of outgoing packets.

In a sixth embodiment (which may or may not be combined with the first, second, third, fourth, and/or fifth embodiments), the processing circuitry may be configured to simultaneously update the first security database, while performing packet classification utilizing the second security database.

In a seventh embodiment (which may or may not be combined with the first, second, third, fourth, fifth, and/or sixth embodiments), the selected security database may include a tree structure. Further, the processing circuitry may be configured to cause classification of the at least one packet with an algorithm that uses the tree structure of the selected security database.

In an eighth embodiment (which may or may not be combined with the first, second, third, fourth, fifth, sixth, and/or seventh embodiments), the selection of the at least one algorithm may be based on criteria related to a subnet, a flow, and/or a VLAN identified by the at least one packet. As still yet another option, the selection of the at least one algorithm may be based the classification.

In a ninth embodiment (which may or may not be combined with the first, second, third, fourth, fifth, sixth, seventh, and/or eighth embodiments), the processing circuitry may be configured to offload the at least one packet to hardware configured to classify the at least one packet utilizing the selected security database. As an option, the hardware may include a content addressable memory and/or an application specific integrated circuit.

In a tenth embodiment (which may or may not be combined with the first, second, third, fourth, fifth, sixth, seventh, eighth, and/or ninth embodiments), the processing circuitry may be configured to utilize the selected security database via cache memory, in connection with the classification of the at least one packet.

To this end, in some optional embodiments, one or more of the foregoing features of the aforementioned system and/or method may enable the use of smaller databases by dividing conventionally-used or other databases into smaller databases that are allocated for use in packet classification involving only a certain subset of packets. By using multiple, smaller databases, there may be more flexibility in processing different packets differently (e.g. in terms of packet classification algorithms, hardware offloading, etc. used). Further, the smaller database size may also enable use of more effective (yet possibly more complex) data structures (e.g. tree structures, etc.) that, in turn, enable the use of more effective packet classification algorithms. Still yet, by virtue of the smaller size of the databases, a database update process may be faster, as well. The use of the multiple, smaller databases may also permit the packet classification to more readily employ the use of cache memories (which are typically smaller than database memory, but more costly). Further, by dividing the databases in the foregoing manner, the packet classification of different packets, as well as database updates, may occur in parallel.

Some or all of the foregoing factors, in turn, may enable more effective, less expensive, and/or faster packet classification that would otherwise be foregone in systems that lack such capabilities. It should be noted that the aforementioned potential advantages are set forth for illustrative purposes only and should not be construed as limiting in any manner.

### BRIEF DESCRIPTION OF THE DRAWINGS

FIG. 1 illustrates a packet classification system for packet classification using multiple security databases, in accordance with one embodiment.

FIG. 2 illustrates exemplary security policy databases (SPDs) for use during packet classification, in accordance with one embodiment.

FIG. 3 illustrates exemplary security association databases (SADs) for use during packet classification, in accordance with one embodiment.

FIG. 4 illustrates a method for packet classification using multiple security databases, in accordance with one embodiment.

FIG. 5 illustrates a network architecture, in accordance with one embodiment.

FIG. 6 illustrates an exemplary system, in accordance with one embodiment.

### DETAILED DESCRIPTION

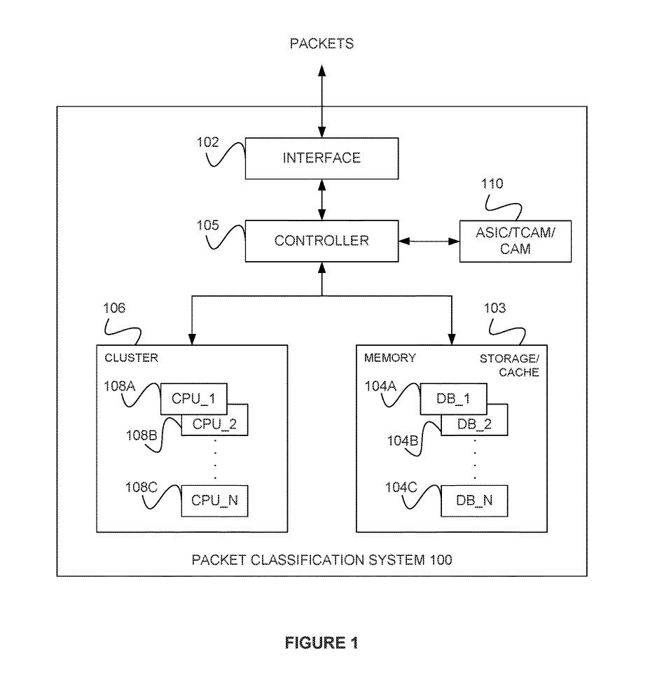

FIG. 1 illustrates a packet classification system 100 for packet classification using multiple security databases, in accordance with one embodiment. As shown, the packet classification system 100 includes an interface 102 in communication with processing circuitry in the form of a controller 105 that, in turn, is in communication with a processor cluster 106 including a plurality of processor cores 108A, 108B, 108C. The controller 105 is further in communication with a memory 103 including a plurality of security databases 104A, 104B, 104C. As shown, the memory 103 may include both database storage as well as cache memory. The security databases 104A, 104B, 104C may be selectively deployed in either the database storage or in the cache storage, for reasons that will soon become apparent.

While not shown, the controller 105 may comprise a particular core in the processor cluster 106, or any other circuitry capable of controlling the packet classification system 100 in a manner that will be described later. Still yet, for reasons that will soon become apparent, the controller 105 is in communication with offload hardware 110 in the form of an application specific circuit (ASIC), content-addressable memory (CAM) such as ternary content-addressable memory (TCAM), and/or any other hardware capable of accelerated processing through specialized hardware. More information will now be set forth regarding the configuration, operability, and cooperation of each of the foregoing components.

In the context of the present description, the security databases 104A, 104B, 104C may refer to any data structure configured for use in connection with packet classification in accordance with an Internet security protocol. Further, the Internet security protocol may refer to any protocol that involves the secure processing and/or communicating of packets. Examples of Internet security protocols may include, but are not limited to an Internet Protocol Security (IPsec) protocol and/or a secure socket layer (SSL) protocol [which is also known as the transport layer security (TLS) protocol]. Still yet, the aforementioned packet classification may involve any processing (e.g. categorization, sorting, grouping, etc.) of the packets in connection with the aforementioned Internet security protocol to support the secure processing and/or communication of the packets.

In one possible embodiment, the security databases 104A, 104B, 104C may each include a security association database (SAD) that stores information on a relationship between different communicating devices and a manner in which such devices use security services to communicate securely. In another possible embodiment, the security databases 104A, 104B, 104C may each include a security policy database (SPD) that stores information on policies that determine a disposition of packets. Non-limiting examples of such information include an index, direction, local Internet Protocol (IP) sharing information, local port sharing information, inbound/outbound security association information, action information, etc.

Still yet, the security databases 104A, 104B, 104C may be configured with any desired data structure. For example, in one embodiment, one or more of the security databases 104A, 104B, 104C may be configured with a tabular and/or column-type data structure. In other embodiments, one or more of the security databases 104A, 104B, 104C may be configured with a tree structure, which may enable more effective algorithms to be used in connection with packet classification.

For reasons that will soon become apparent, one or more of the security databases 104A, 104B, 104C may, in some embodiments, be generated by dividing a particular security database (e.g. a SAD, SPD, etc.) such that a first one of the security databases 104A includes a first subset of the particular security database and a second one of the security databases 104B includes a second subset of the particular security database. Thus, a plurality of the security databases 104A, 104B, 104C may be of the same type (e.g. SAD, SPD, etc.), but may be smaller by virtue of the aforementioned division. Further, such division may be governed by a particular subset of packets that the particular security database is to be used for classifying the packets.

For example, the first security database 104A may be used in classifying packets that are common with respect to a particular aspect, while the second security database 104B may be used in classifying different packets that are also common with respect to the foregoing particular aspect. Such particular aspect may include, but is not limited to a subnet identified by the at least one packet, a flow identified by the at least one packet, and/or a virtual local area network (VLAN) identified by the at least one packet. As a further option, the particular aspect may involve whether the at least one packet is an incoming packet or an outgoing packet. In such embodiment, the first security database 104A may be configured for use in connection with packet classification of incoming packets, and the second security database 104B may be configured for use in connection with packet classification of outgoing packets.

By this design, the controller 105 is configured to receive at least one (incoming or outgoing) packet that has been/is to be communicated via the interface 102, and identify at least one aspect of such packet(s), for the purpose of controlling the use of one or more of: the security databases 104A, 104B, 104C; the processor cores 108A, 108B, 108C; and/or the offload hardware 110/cache memory 103 in connection with packet classification. For example, the controller 105 may be configured to select one of the security databases 104A, 104B, 104C as a selected security database, based on the aspect(s) of the packet(s). To this end, classification of the packet(s) may be carried out, utilizing the selected security database.

In various optional embodiments, such packet classification may be carried out in any desired manner. For example, in one embodiment, the controller 105 may select one or more of the processor cores 108A, 108B, 108C to process the packet(s) using the selected security database. Through the use of such processor cores 108A, 108B, 108C in such manner, the controller 105 may flexibly employ such resources to carry out packet classifications using different algorithms involving different packets. Further, this may be accomplished while also using such resources to simultaneously carry out other tasks (such as database updates), under the direction of the controller 105. In some embodiments, the controller 105 may also select a particular classification algorithm, as well as make a decision whether to offload processing to the offload hardware 110 and/or use cache memory 103 during packet classification, based on any of the aforementioned criteria (where such criteria may be the same or different with respect to each decision and/or with respect to the aspect that drives database selection).

To this end, in some optional embodiments, one or more of the foregoing features may enable the use of smaller databases by dividing conventionally-used or other databases into smaller databases that are allocated for use in packet classification involving only a certain subset of packets. By using multiple, smaller databases, there may be more flexibility in processing different packets differently (e.g. in terms of packet classification algorithms, hardware offloading, use of cache memory, etc.). Further, the smaller database size may also enable use of more effective (yet possibly more complex) data structures (e.g. tree structures, etc.) that, in turn, enable the use of more effective packet classification algorithms. Still yet, by virtue of the smaller size of the databases, a database update process may be faster, as well.

The use of the multiple, smaller databases also allows the packet classification to more readily employ the use of cache memories (which are typically smaller than database memory, but more costly). Specifically, conventional databases may be too large to implement using conventionally-sized cache memories. Thus, the use of smaller databases may enable use of cache memories, without necessarily increasing an overall cost of a system.

Further, by dividing the databases in the foregoing manner, the packet classification of different packets, as well as database updates, may occur in parallel. For example, one database may be used for packet classification in connection with one certain subset of packets, while another database may be used for packet classification in connection with another certain subset of packets. Further, one database may be updated, while another is used for packet classification.

Some or all of these factors, in turn, enable more effective, less expensive, and/or faster packet classification, due to: the use of smaller databases, the more prevalent use of cache memory/hardware offloading, as well as the use of the aforementioned flexibility/parallelism. It should be noted that the aforementioned potential advantages are set forth for illustrative purposes only and should not be construed as limiting in any manner. More illustrative information will now be set forth regarding various optional architectures and uses in which the foregoing techniques may or may not be implemented, per the desires of the user. Any of the following features may be optionally incorporated with or without the exclusion of other features described.

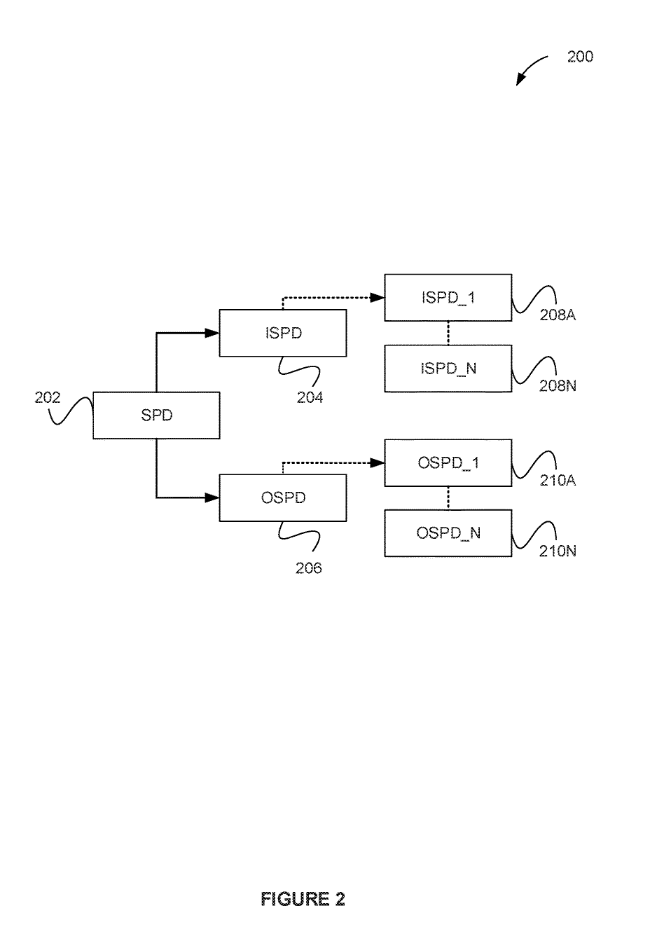

FIG. 2 illustrates exemplary SPDs 200 for use during packet classification, in accordance with one embodiment. As an option, the SPDs 200 may be implemented in the context of any one or more of the embodiments set forth in any previous and/or subsequent figure(s) and/or description thereof. For example, the SPDs 200 may be used in the context of the security databases 104A, 104B, 104C of the system 100 of FIG. 1. However, it is to be appreciated that the SPDs 200 may be implemented in the context of any desired environment.

As shown, the SPDs 200 include a SPD 202 that is divided into a plurality of databases, namely an incoming security policy database (ISPD) 204 and an outgoing security policy database (OSPD) 206. Specifically, the ISPD 204 is equipped with fields, field values, and other contents that are specific only to incoming packets, and is thus equipped for use with only classifying incoming packets. Further, the OSPD 206 is equipped with fields, field values, and other contents that are specific only to outgoing packets, and is thus equipped for use with only classifying outgoing packets. In one embodiment, the aforementioned division may be such that that, collectively, the contents of the ISPD 204 and the OSPD 206 may be similar (or the same as) the SPD 202.

Strictly as an option, the ISPD 204 and the OSPD 206 may be further divided based on any other aspect(s) of the packets to be classified, thus affording a plurality of ISPDs (e.g. ISPD_1 . . . N 208A . . . 208N) and/or a plurality of OSPDs (e.g. OSPD_1 . . . N 210A . . . 210N). As mentioned earlier, such aspect(s) may include, but is not limited to a subnet, a flow, and/or a VLAN associated with the packet(s) to be classified.

Further, while the division is set forth in the specific manner illustrated, it should be noted that any aspect of the division may be rearranged, omitted, etc. in any desired manner. For example, in one embodiment, the SPD 202 may be divided only based on the subnet, flow, and/or VLAN aspects, or may even be divided more than shown. Further, as an additional option, the SPD 202 may be included as one of the available databases (e.g. one of the security databases 104A, 104B, 104C of the system 100 of FIG. 1) so that more conventional packet classification may be applied in addition to/instead of packet classification involving one of the divided databases, as desired.

By this design, the ISPD 204, the OSPD 206, ISPD_1 . . . N 208A . . . 208N, and OSPD_1 . . . N 210A . . . 210N each include only a subset of the SPD 202 and are thus configured for use with only a subset of the packets that are in need of classification. To this end, processing circuitry (e.g. the controller 105 of FIG. 1) may be configured to select only a subset (e.g. 1, 2, 3, etc.) of such security databases for use during packet classification. Further, the aforementioned processing circuitry may selectively apply different algorithms and hardware offloading, while more frequently using cache memory, when carrying out packet classification via the different security databases.

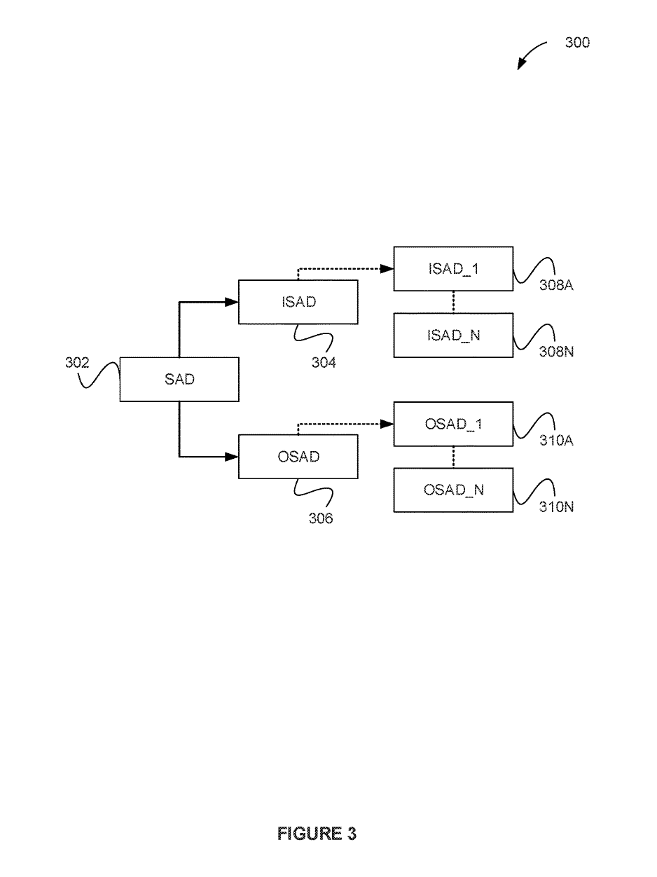

FIG. 3 illustrates exemplary SADs 300 for use during packet classification, in accordance with one embodiment. As an option, the SADs 300 may be implemented in the context of any one or more of the embodiments set forth in any previous and/or subsequent figure(s) and/or description thereof. For example, the SADs 300 may be used in the context of the security databases 104A, 104B, 104C of the system 100 of FIG. 1. However, it is to be appreciated that the SADs 300 may be implemented in the context of any desired environment.

As shown, the SADs 300 include a SAD 302 that is divided into a plurality of databases, namely an incoming security association database (ISAD) 304 and an outgoing security association database (OSAD) 306, divided in a manner similar to the SPD 202 of FIG. 2. Further, strictly as an option, the ISAD 304 and the OSAD 306 may be further divided based on any other aspect(s) of the packets to be classified, thus affording a plurality of ISADs (e.g. ISAD_1 . . . N 308A . . . 308N) and/or a plurality of OSADs (e.g. OSAD_1 . . . N 310A . . . 310N).

By this design, the ISAD 304, the OSAD 306, ISAD_1 . . . N 308A . . . 308N, and OSAD_1 . . . N 310A . . . 310N each include only a subset of the SAD 302 and are thus configured for use with only a subset of the packets that are in need of classification. To this end, processing circuitry (e.g. the controller 105 of FIG. 1) may be configured to select only a subset (e.g. 1, 3, 3, etc.) of such security databases for use during packet classification. Further, the aforementioned processing circuitry may selectively apply different algorithms and hardware offloading, while more prevalently using cache memory, when carrying out packet classification via the different security databases.

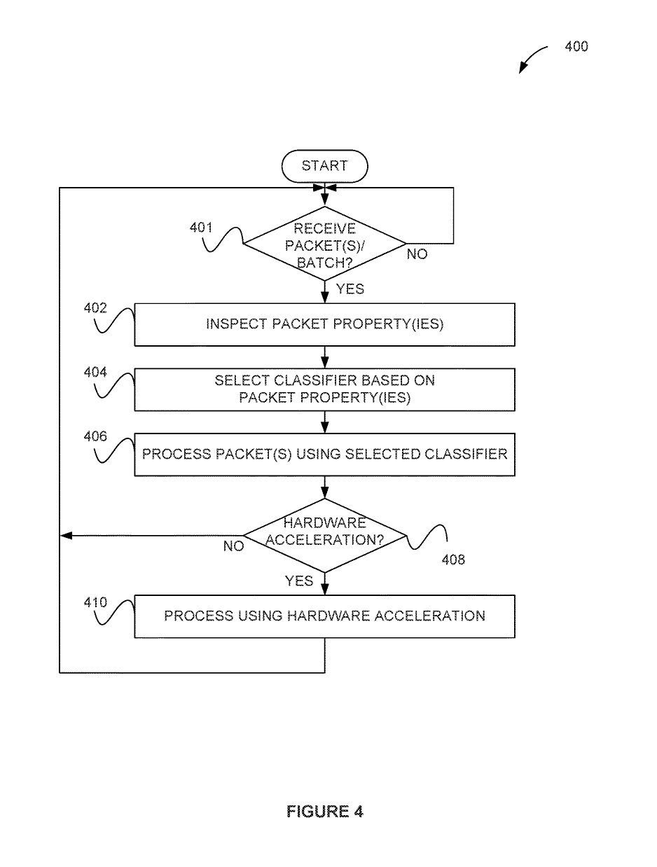

FIG. 4 illustrates a method 400 for packet classification using multiple security databases, in accordance with one embodiment. As an option, the method 400 may be implemented in the context of any one or more of the embodiments set forth in any previous and/or subsequent figure(s) and/or description thereof. Just by way of example, the method 400 may be carried out in the context of the system 100 of FIG. 1, and/or using the various databases of FIGS. 2-3. However, it is to be appreciated that the method 400 may be implemented in the context of any desired environment.

As shown, the method 400 begins with the receipt of one or more packets (or even a batch of packets) per decision 401. It should be noted that, in one embodiment, only a subset of all received packets are inspected, while, in other embodiments, all received packets are inspected. In any case, upon receipt, the packet(s) are inspected for one or more aspects (e.g. properties, etc.) in step 402. In various embodiments, this may be accomplished by inspecting various fields of the packet(s). From such fields, the various aspects (e.g. subnet, flow, VLAN, etc.) of the packet(s) may be identified.

Based on the properties identified in step 402, a packet classifier (e.g. classification engine, etc.) is selected in step 404 for determining a classifying algorithm to be applied to the packet(s). In the context of the present description, such packet classifier may involve any combination of one or more of: the processor cores (e.g. cores 108A, 108B, 108C of FIG. 1, etc.) to be used, the databases (e.g. databases 104A, 104B, 104C of FIG. 1, etc.) to be used, the algorithm to be used, and/or the cache memory to be used.

Further, it should be noted that any one or more of the foregoing classifier components may also be selected based on any other factors (instead of or in addition to the packet properties). Just by way of example, the packet classification algorithm may be selected based on the database chosen. For instance, the packet classification algorithm may be chosen that leverages a particular data structure (e.g. tree structure, etc.) of a particular security database. Examples of such algorithms include, but are not limited to fast packet classification algorithms other than linear search algorithms [e.g. hierarchical intelligent cuttings (HiCuts), recursive flow classification (RFC), EFFICUTS, etc.].

Still yet, as an additional option, the packet classification algorithm may be selected based on any other desired factors. For example, such factors may include, but are not limited to a load on the packet classification process, a quality of service (QoS) policy, a priority assigned to any of the various aspects disclosed herein (e.g. subnet, flow, VLAN, etc.).

With continuing reference to FIG. 4, the packet(s) are processed in step 406 using the selected classifier. Further, it may be determined whether any hardware offloading (e.g. via the offload hardware 110 of FIG. 1, etc.) should occur, per decision 408. As mentioned earlier, such hardware may include a CAM, TCAM, ASIC, etc. Further, the decision 408 may be a default decision or may be based on any of the packet properties and/or any other factors disclosed hereinabove. To this end, in step 410, the method 400 may conditionally offload the packet(s) to hardware configured to classify the packet(s) utilizing the selected security database. Thus, the offload hardware may be used more efficiently.

While not shown, at any step of the method 400, one or more databases (that are not currently being used for packet classification) may be updated while the selected database is used for packet classification. Further, the method 400 may iterate for different packets or groups of packets, so that different packet classifiers (e.g. classification engines, etc.) and optional hardware offloading may be tailored for different packet properties (and/or other previously-mentioned factors). Thus, different packets (e.g. inbound vs. outbound) may be treated differently, while more effectively employing parallelism, cache memory usage, optimal classification algorithms, etc.

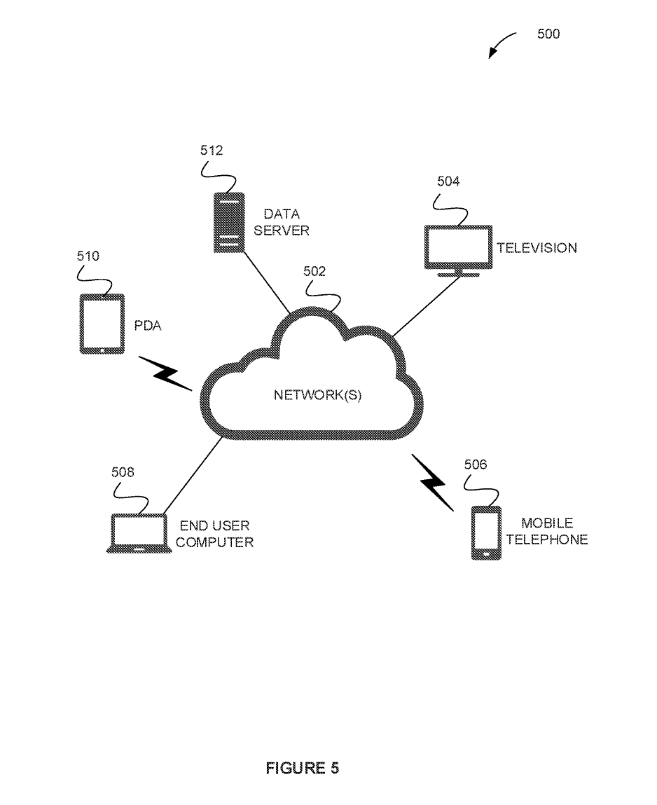

FIG. 5 illustrates a network architecture 500, in accordance with one embodiment. As shown, at least one network 502 is provided. In various embodiments, any one or more components/features set forth during the description of any previous figure(s) may be implemented in connection with any one or more of the components of the at least one network 502. For example, any one or more of the components of the at least one network 502 may be equipped with the apparatus 100 of FIG. 1 to facilitate communication among other components of the at least one network 502.

In the context of the present network architecture 500, the network 502 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 502 may be provided.

Coupled to the network 502 is a plurality of devices. For example, a server computer 512 and a user computer 508 may be coupled to the network 502 for communication purposes. Such user computer 508 may include a desktop computer, lap-top computer, and/or any other type of logic. Still yet, various other devices may be coupled to the network 502 including a personal digital assistant (PDA) device 510, a mobile phone device 506, a television 504, etc.

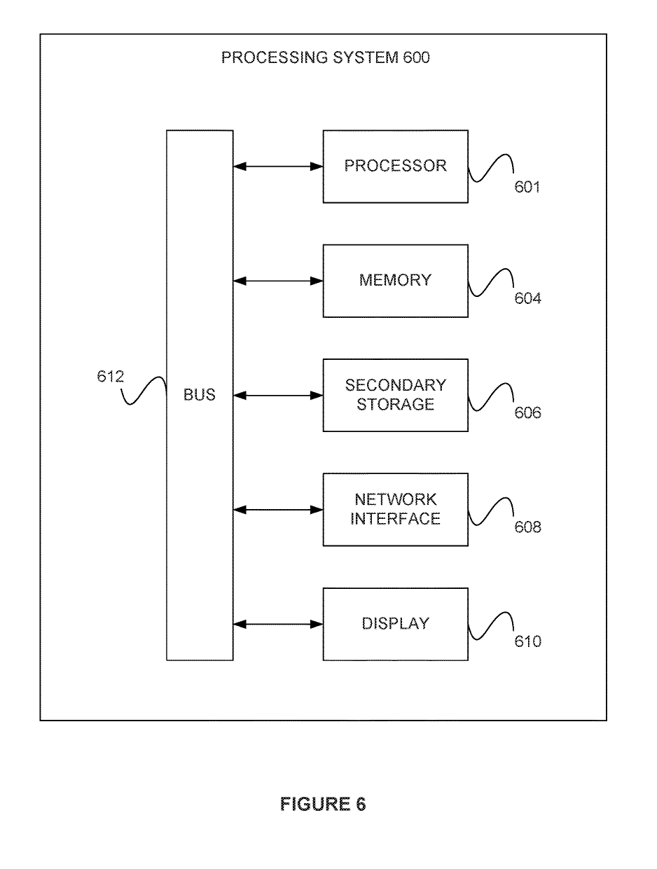

FIG. 6 illustrates an exemplary processing system 600, in accordance with one embodiment. As an option, the processing system 600 may be implemented in the context of any of the devices of the network architecture 500 of FIG. 5. However, it is to be appreciated that the system processing 600 may be implemented in any desired environment.

As shown, the processing system 600 is provided including at least one processor 602 which is connected to a bus 612. The processing system 600 also includes memory 604 [e.g., hard disk drive, solid state drive, random access memory (RAM), etc.]. The processing system 600 also includes a display 610, and a network interface 608 for communicating packets over a network.

The system processing 600 may also include a secondary storage 606. The secondary storage 606 includes, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the memory 604, the secondary storage 606, and/or any other memory, for that matter. Such computer programs, when executed, enable the processing system 600 to perform various functions (as set forth above, for example). Memory 604, secondary storage 606 and/or any other storage are possible examples of non-transitory computer-readable media.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), and the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein include the one or more modes known to the inventor for carrying out the claimed subject matter. It is to be appreciated that variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A packet classification system, comprising:
a first security database configured for use in connection with packet classification in accordance with an Internet security protocol;
a second security database configured for use in connection with the packet classification in accordance with the Internet security protocol; and
processing circuitry in communication with the first security database and the second security database, the processing circuitry configured to:
identify at least one aspect of at least one packet received by the processing circuitry;
select either the first security database or the second security database as a selected security database, based on the at least one aspect of the at least one packet;
select at least one of a plurality of algorithms to classify the at least one packet, wherein the selection of the at least one algorithm is based on a criteria related to the at least one packet; and
classify the at least one packet, utilizing the selected security database and the selected at least one algorithm.

2. The packet classification system of claim 1, wherein the first security database and the second security database each includes a security association database.

3. The packet classification system of claim 1, wherein the first security database and the second security database each includes a security policy database.

4. The packet classification system of claim 1, wherein the first security database is configured for use in connection with packet classification of incoming packets, and the second security database is configured for use in connection with packet classification of outgoing packets.

5. The packet classification system of claim 1, wherein the Internet security protocol includes at least one of an Internet Protocol Security (IPsec) protocol or a secure socket layer (SSL) protocol.

6. The packet classification system of claim 1, wherein the packet classification system is configured such that the first security database and the second security database are generated by dividing a particular security database such that the first security database includes a first subset of the particular security database and the second security database includes a second subset of the particular security database.

7. The packet classification system of claim 1, wherein the packet classification system is configured such that the at least one aspect of the at least one packet involves whether the at least one packet is an incoming packet or an outgoing packet.

8. The packet classification system of claim 1, wherein the packet classification system is configured such that the at least one aspect of the at least one packet includes one or more of a subnet identified by the at least one packet, a flow identified by the at least one packet, or a virtual local area network (VLAN) identified by the at least one packet.

9. The packet classification system of claim 1, wherein the processing circuitry is configured to simultaneously update the first security database while performing packet classification utilizing the second security database.

10. The packet classification system of claim 1, wherein the packet classification system is configured such that the selected security database includes a tree structure.

11. The packet classification system of claim 10, wherein the processing circuitry is configured to classify the at least one packet with an algorithm that uses the tree structure of the selected security database.

12. The packet classification system of claim 1, wherein the criteria is related to at least one of a subnet, a flow, or a virtual local area network (VLAN) identified by the at least one packet.

13. The packet classification system of claim 1, wherein the processing circuitry is configured such that the selection of the at least one algorithm is based on the classification.

14. The packet classification system of claim 1, wherein the processing circuitry is configured to offload the at least one packet to classification hardware configured to classify the at least one packet utilizing the selected security database.

15. The packet classification system of claim 1, wherein the processing circuitry is configured to utilize the selected security database via cache memory.

16. A packet classification method, comprising:
a packet classification system identifying at least one aspect of at least one packet received by the packet classification system;
the packet classification system selecting a first security database or a second security database as a selected security database, based on the at least one aspect of the at least one packet;
the packet classification system selecting at least one of a plurality of algorithms to classify the at least one packet, wherein the selection of the at least one algorithm is based on a criteria related to the at least one packet; and
the packet classification system classifying the at least one packet, utilizing the selected security database and the selected at least one algorithm.

17. The packet classification method of claim 16, wherein the first security database and the second security database each includes a security association database.

18. The packet classification method of claim 16, wherein the first security database and the second security database each includes a security policy database.

19. The packet classification method of claim 16, wherein the first security database is configured for use in connection with packet classification of incoming packets, and the second security database is configured for use in connection with packet classification of outgoing packets.

20. The packet classification method of claim 16, wherein the Internet security protocol includes at least one of an Internet Protocol Security (IPsec) protocol or a secure socket layer (SSL) protocol.

21. The packet classification method of claim 16, wherein the first security database and the second security database are generated by dividing a particular security database such that the first security database includes a first subset of the particular security database and the second security database includes a second subset of the particular security database.

22. The packet classification method of claim 16, wherein the at least one aspect of the at least one packet involves whether the at least one packet is an incoming packet or an outgoing packet.

23. The packet classification method of claim 16, wherein the at least one aspect of the at least one packet includes one or more of a subnet identified by the at least one packet, a flow identified by the at least one packet, or a virtual local area network (VLAN) identified by the at least one packet.

24. The packet classification method of claim 16, wherein the first security database is simultaneously updated while performing packet classification utilizing the second security database.

25. The packet classification method of claim 16, wherein the selected security database includes a tree structure.

26. The packet classification method of claim 25, wherein the at least one packet is classified using the tree structure of the selected security database.

27. The packet classification method of claim 16, wherein the criteria is related to at least one of a subnet, a flow, or a virtual local area network (VLAN) identified by the at least one packet.

28. The packet classification method of claim 16, wherein the selection of the at least one algorithm is based on the classification.

29. The packet classification method of claim 16, wherein the selected security database is utilized via cache memory.

30. A non-transitory computer-readable media storing computer instructions, that when executed by one or more processors, cause the one or more processors to perform the steps of:
identifying at least one aspect of at least one packet received by the one or more processors;
selecting a first security database or a second security database as a selected security database, based on the at least one aspect of the at least one packet;
selecting at least one of a plurality of algorithms to classify the at least one packet, wherein the selection of the at least one algorithm is based on a criteria related to the at least one packet; and
classifying the at least one packet utilizing the selected security database and the selected at least one algorithm.
